(19) United States
(12) Patent Application Publication
(10) Pub. No.: US 2018/0316689 A1
(43) Pub. Date: Nov. 1, 2018

(54) SYSTEM AND HEURISTICS FOR VERIFYING ORIGIN OF REQUEST

(71) Applicant: Web Service Development, Tokyo Ota District Nishi-Kamata (JP)

(72) Inventors: Kosei Ogawa, Tokyo (JP); Benjamin Maxwell Collins, Tokyo (JP)

(21) Appl. No.: 15/581,685

(22) Filed: Apr. 28, 2017

(51) Int. Cl. H04L 29/06; H04L 29/08; H04L 29/12

(52) U.S. Cl. CPC H04L 63/126; H04L 63/083; H04L 63/0884; H04L 63/10; H04L 67/141; H04L 63/06; H04L 67/146; H04L 61/2007; H04L 67/10; H04L 63/0428

(57) ABSTRACT

A system and method for verifying the origin of a request over a network is provided. The system includes a personal electronic device in communication with one or more databases and servers through a network. The servers configured to generate a session ID and a session confirmation package used to identify a particular user. The session confirmation package including an IP address of the personal electronic device and the browser agent. The servers and databases configured to subsequently generate a session verification key for each session of the user. The session verification key is automatically updated upon each access and verification. The session verification key is updated on the personal electronic device when a third party device accesses the network with copied verification keys and ID. The third party device fails to receive the new updated session verification key and is denied access.

### BACKGROUND

### 1. Field of the Invention

The present application relates to a system, program, and heuristics for confirming the origin of a request within a computer network so as to prevent the inadvertent transfer of information to unauthorized computers.

### 2. Description of Related Art

Http (HyperText Transfer Protocol) is a protocol for sending media over networks and is one of the most common protocols used on the internet. Information can be requested from a client computer with a specific IP Address to a host computer with an IP Address on the same network. In some cases the request may require some form of validation from the host computer, such as a username and password, or other parameter which the host computer recognizes as a valid signature.

In order to distinguish a requests to and from computers which have been authenticated over the network, a host computer will often generate what is known as a cookie. A cookie is most often a sufficiently randomly generated set of characters and numbers such that the set of characters and numbers is not easily forged by other computers on the network. These cookies are issued by the host computer, and sent in the header of every request made from the client computer.

One problem with cookies, is that because they are included in the header of an Http request, computers on the network of the client and source computer are able to read them. In other cases, such as with Cross Site Scripting attacks, the client computer is tricked into executing code which causes the client computer to send an http request to a third party computer on the network with the cookie attached to the request. Upon obtaining the cookie, or random set of characters and numbers which the client computer uses to authenticate itself to the host computer, the third party can attach this cookie to their Http requests to masquerade as the client computer.

Although strides have been made to increase security within a network, shortcomings remain. A system and method is needed to ensure that a computer that is authenticated is the computer actually making the requests. In other words, a system is needed that not only confirms a login (i.e. through a cookie perhaps) but also confirms that the origin of the login is the same as that of the computer that logged in.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a graphic of a system for verifying origin of request within a network according to an embodiment of the present application.

FIGS. 2-9 are graphics showing the process of logging into the system for verifying origin of request of FIG. 1.

FIGS. 10-13 are graphics showing the process of logging out of the system for verifying origin of request of FIG. 1.

FIGS. 14-16 are graphics showing an exemplary operation of the system for verifying origin of request of FIG. 1 with multiple sessions and multiple connections.

FIG. 17 is a graphic of a process in which sessions are terminated when a user fails to logout from the system for verifying origin of request of FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with traditional security devices for doors. In particular, the system is configured to provide a multi-layer authentication protocol to verify the user or computer logging in as well as that the origin of the login is the same as that of the computer that logged in. Successive keys are generated by the system to authenticate the user and the computer on the network prior to disseminating sensitive information. Additionally, the system is configured to automatically update session confirmation keys of existing computers on the network upon the connection of a subsequent computer, such that the subsequent computer fails to retrieve the correct and updated session confirmation key. These and other unique features of the device are discussed below and illustrated in the accompanying drawings.

The system and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system and method of the present application is illustrated in the associated drawings. The system includes one or more computers in communication over a network to any number of servers and/or databases for the transfer of information. The system is configured to provide a multi-layered confirmation of the user and the computer through the network. Additional features and functions of the device are illustrated and discussed below.

The system of the present application as described in the associated figures can include one or more various electronic devices configured to communicate over a network. Any of these devices may include at least any of an input/output (I/O) interface, a processor, a database, and a maintenance interface to facilitate proper communication and the transfer of executable data. Embodiments of the system can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface provides a communication link between external users, systems, and data sources and components of the system. The I/O interface can be configured for allowing one or more users to input information to the system via any known input device. Examples can include a keyboard, mouse, touch screen, microphone, and/or any other desired input device. The I/O interface can be configured for allowing one or more users to receive information output from the system via any known output device. Examples can include a display monitor, a printer, a speaker, and/or any other desired output device. The I/O interface can be configured for allowing other systems to communicate with the system. For example, the I/O interface can allow one or more remote computer(s) to access information, input information, and/or remotely instruct the system to perform one or more of the tasks described herein. The I/O interface can be configured for allowing communication with one or more remote data sources. For example, the I/O interface can allow one or more remote data source(s) to access information, input information, and/or remotely instruct the system to perform one or more of the tasks described herein.

The database provides persistent data storage for the system. While the term “database” is primarily used, a memory or other suitable data storage arrangement may provide the functionality of the database. In alternative embodiments, the database can be integral to or separate from the system and can operate on one or more computers. The database preferably provides non-volatile data storage for any information suitable to support the operation of the system, including various types of data discussed below in connection with the Figures.

The maintenance interface is configured to allow users to maintain desired operation of the system. In some embodiments, the maintenance interface can be configured to allow for reviewing and/or revising the data stored in the database and/or performing any suitable administrative tasks commonly associated with database management. This can include, for example, updating database management software, revising security settings, and/or performing data backup operations. In some embodiments, the maintenance interface can be configured to allow for maintenance of the processor and/or the I/O interface. This can include, for example, software updates and/or administrative tasks such as security management and/or adjustment of certain tolerance settings.

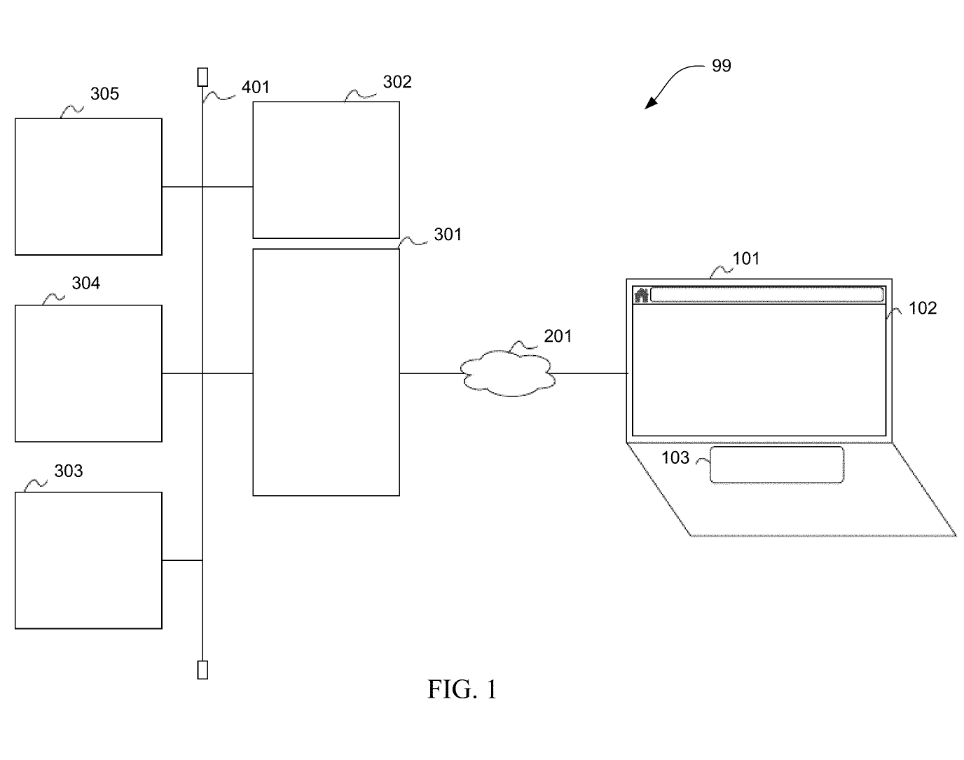

Referring now to the drawings wherein like reference characters identify corresponding or similar elements in form and function throughout the several views. In FIG. 1, the system 99 for verifying origin of request within a network is illustrated. FIG. 1 shows the overall structure of the present application. System 99 includes an electronic device 101 (i.e. a Personal Computer) and a series of databases and/or servers 301-305. Device 101 includes a processor, some method of memory, non-volatile storage, networking, input and output. Other devices apart from the depicted personal computer may be operable within system 99. For example, device 101 may then include any device similar in functionality, such as a smartphone, tablet or otherwise smart device will suffice.

Web Browser 102 is operable on device 101 and able to send and receive TCP requests over internet 201 (series of networks) as data. Additionally, they may render data as an image on the screen, or execute code downloaded from a host on the network or otherwise send or receive requests using the Http protocol. File system 103 of device 101 is able to communicate with web browser 102 and store selected information. File system 103 is used to save data such as cached websites, images, cookies and other information for the Web Browser 102 to make use of.

Internet 201 is often referred to as the cloud. It's a system of networks that covers the globe using various mechanisms, such as Network Address translation and IP address routing, to take a request from one computer on one side of the network, forward it to another computer on the network, and then transfer the response back to the computer which made the original request.

Reverse proxy server 301 is a computer which acts as an endpoint in the internet and forwards traffic to other computers on a separate network from the internet to which the Reverse proxy server 301 is attached to. The effect of this is allows several servers to appear as one endpoint to a web client which requires single domain policy. The reason for the separation in the present application is that this allows the Reverse proxy server 301 to run a set of checks on requests to the server, before passing them to other servers on the network to be handled.

302 is a WebSocket Server. WebSockets 302 are an addition to the Http Protocol. They are a TCP connection which requires both connected computers to send pings at given intervals to keep the connection active. If one of two computers sharing a WebSocket connection fails to send a ping within a given time, the connection is considered broken by the opposing computer connection. The protocol also defines handshakes for establishing connections, methods for ending connections, and methods for sending binary or text data over these connections.

303 is an Application Server. Application server 303 is the term the present application uses for a network based server which is able to take requests from a client, and act upon them based against a number of set conditions depending on the authorization level of the given request. For instance, a client may ask for a series of values from a database, or write a series of values on the database, and based on the content of the request, execute those requests from the client. In general, application server 303 is configured to run the applications.

304 is a Data Store Server. Data Store Server 304 performs a similar functionality to a Database Server, but to a different end. A Data Store Server 304 is a network oriented server which stores a given list of values for a given key. And is often done within the device's memory, and not the device's file system. The result of this is a server which has the primary function of managing session data. When a user logs into a Web Application, the web application will create a random session key for information such as the client computer's browser agent or IP address are paired with. Such values are stored in Data Store Server's 304 memory to be accessible by other servers on the network.

305 is a Database Server. Database server 305 is a server with the primary functionality of storing, searching, and writing data in a table or other structure. Other servers with proper authentication on the network can send requests to this server to access data stored on the hard drive.

401 is a network, or the physical media which is used to send signals between servers on the network.

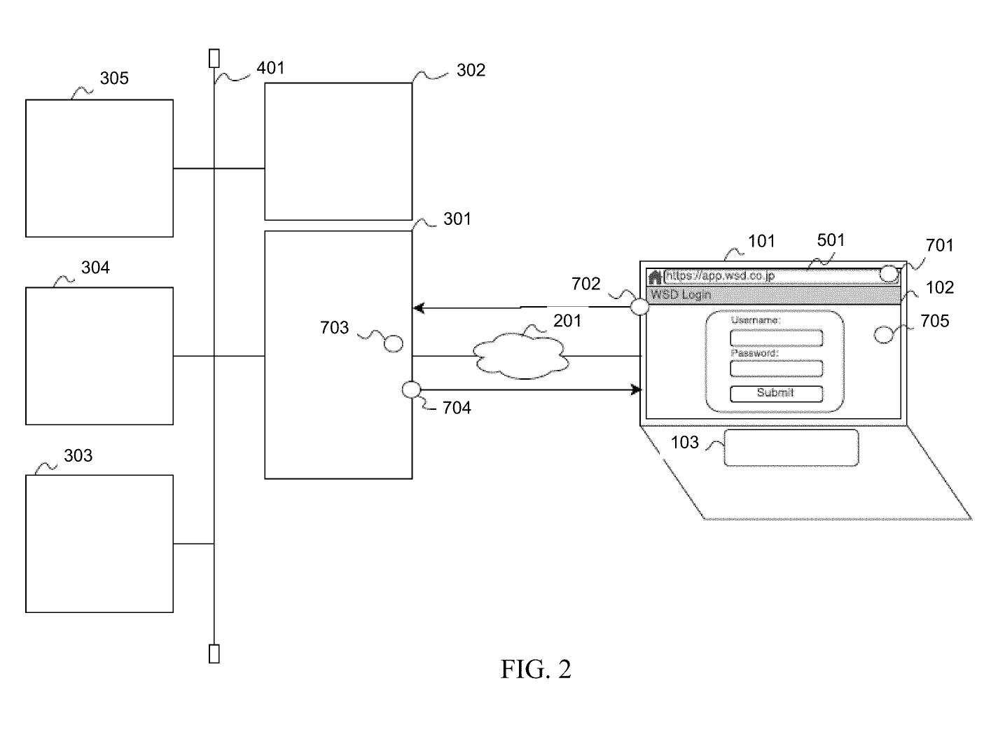

Referring now also to FIGS. 2-9 in the drawings, graphics showing the process of logging into system 99 for verifying origin of request is illustrated. In particular with FIG. 2, at step 701 the URL of the web application is entered into the Web Browser's 102 Address bar 501. At this time (step 702), the Web browser 102 sends an http request to the Reverse Proxy Server 301 for the login. The Reverse Proxy Server 301 reads the files for the login (step 703) and thereafter returns (step 704) an http response back to Web Browser 102. Web Browser 102 renders (step 705) the login page from the http response in step 704.

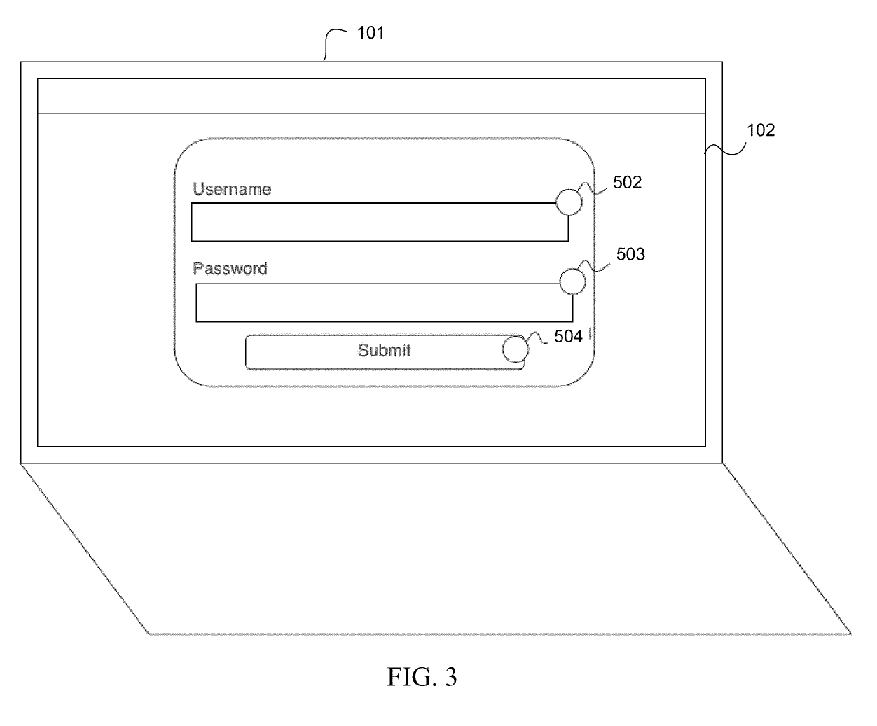

Referring now also to FIG. 3 in the drawings, the Login Screen of the present application is illustrated. The Login Screen follows a common design in which two inputs, one for a username 502 and one for a password 503, is present with a submit button 504. The present application makes no claims to the design of stated login screen. Simply that such a screen is provided to establish the which user is requesting access to the application and said user requires some form of digital signature, such as a password to be authenticated to the application. Such forms also include a submit button 504, which is used to indicate the user has entered their details to be verified by the server.

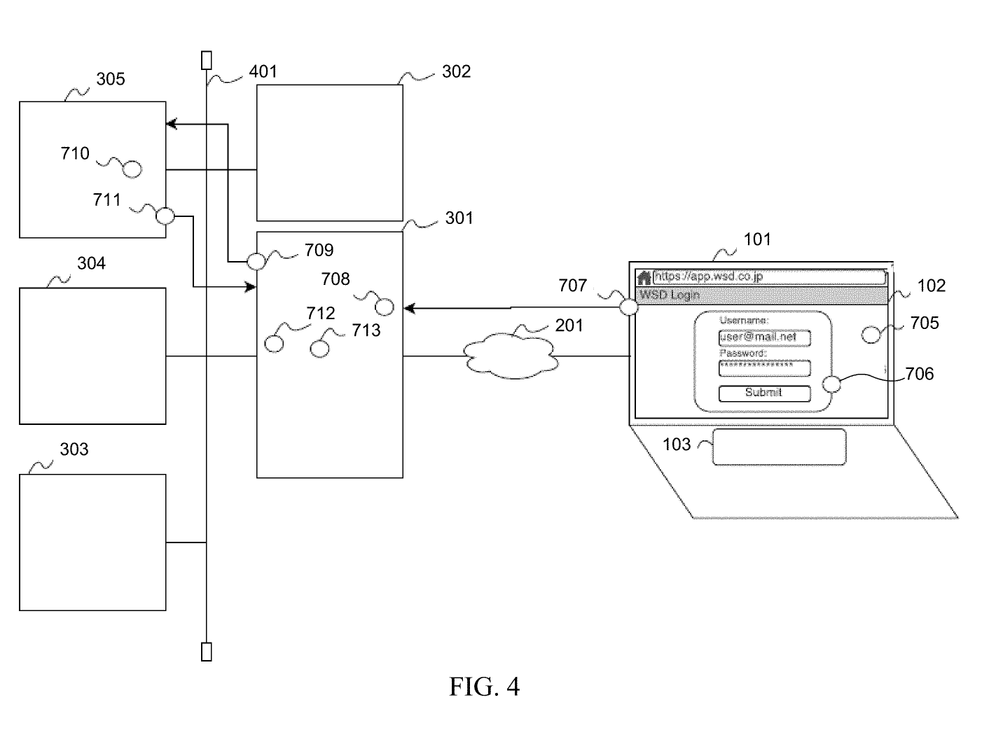

Referring now also to FIG. 4 in the drawings, a series of steps are executed. In step 706, the intended username and password (user identification data) are entered into the input fields for username 502 and password 503 respectively, and the 504 submit button has been clicked. In step 707, the 102 Web Browser sends a POST request to the Reverse Proxy Server 301 with the username and password entered into the username 502 field and password 503 field included in the body of the request. The Reverse Proxy Server 301 parses the POST data (step 708) from the 707 step/request to retrieve the username and password provided from the Web Browser 102. The Reverse Proxy Server 301 sends a request (step 709) to the Database server 305 as to query any users with the username provided from the web client match any in the database.

At this time, the 305 Database Server executes the query for a username (step 710). The Database Server 305 returns the results of the username query to the Reverse Proxy Server 301 (see step 711). In step 712 the Reverse Proxy 301 checks the number of results provided by the Database server 305. If there are no matches in the database, the Reverse Proxy Server 301 stops authentication. The Reverse Proxy server 301 checks the integrity of the provided digital signature (step 713) provided by the Web Server 102. In most cases this revolves around checking a series of characters or numbers against a hash stored in the Database server 305.

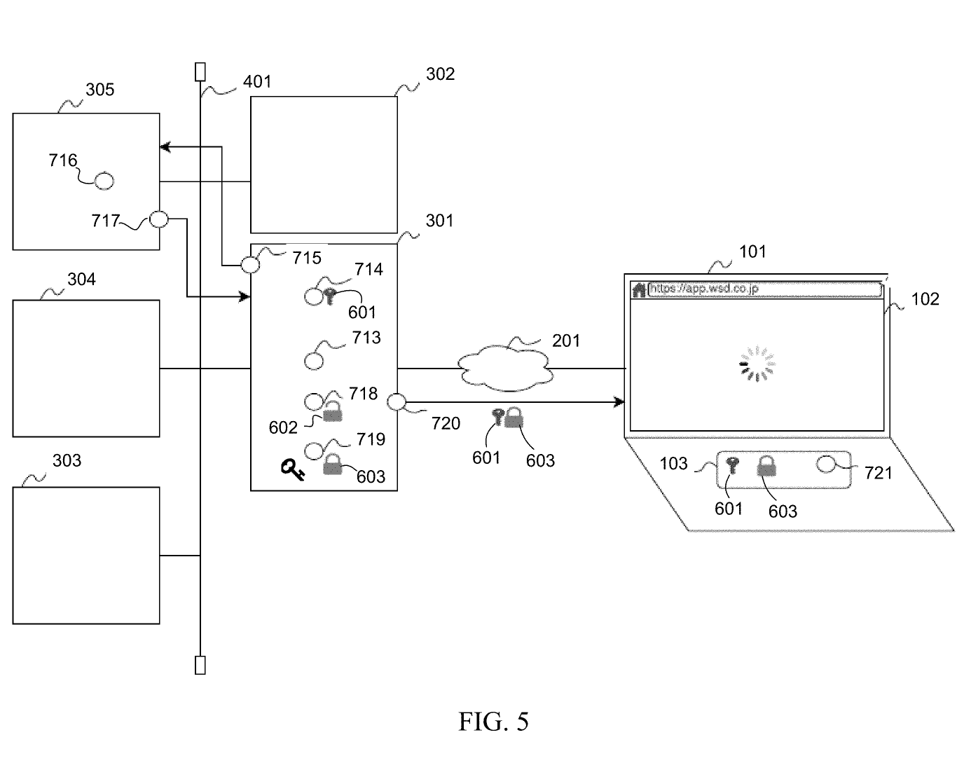

Referring now also to FIG. 5 in the drawings, a series of steps are executed. In step 714, the Reverse Proxy Server 301 creates a Session Key as to identify subsequent requests from the Web Browser 102. A Session Key is a series of number of characters and numbers which is thought to be sufficiently random, such that it cannot be forged by a third party. The present application will use an example value of “l3e6u8s48xebnk1302d”, and illustrate in the Figures where this value is used with a session key 601 icon.

In step 715, the Reverse Proxy Server 301 sends a query to the Database Server 305 to save the Session Key, Browser agent, and origin IP address of the Web Browser 102 in a log. This can be done with a boolean value, which is initially false, indicating the user has not yet logged out, such that it can be requested later for confirmation. In step 716, the Database Server 305 performs the write operation to the file system. In step 717, the Database Server 305 returns a confirmation response to Reverse Proxy Server 301. At this time the Reverse Proxy Server 301 creates (see step 718) what this application with refer to as a 602 “Session Confirmation Package”. A 602 Session Confirmation Package is a data structure such as JSON, or XML or similar format which stores the origin IP address of the Web Browser 102, the Browser Agent of the Web Browser, and the Session Key 115 from step 714 and creates a string which can be parsed at a later time. A JSON example of the session confirmation package is as follows:

‘‘‘
‘{

“ip_address” : “104.131.30.5”,
“session_key” : “l3e6u8s48xebnk1302d”,
“browser_agent” : “Mozilla/5.0 (Windows NT x.y; rv:10.0)

Gecko/20100101 Firefox/10.0”
}‘
‘‘‘

In step 719, the Reverse Proxy Server 301 then encrypts the 602 Session Confirmation Package with a 604 symmetric key which is stored on the Reverse Proxy Server 301 to create a 603 Encrypted Confirmation Package. For example, the example JSON text from step 718, encrypted with the key: 37586153414011199397 would be have a result of the following text:

‘‘‘
B65A75841793DD4612D9CB3B1F8E1B5048B2A59144E11F10D3B13AC2CDE1CBFD
F317A4F9004D1CCBC6BFE47D758E85B011667741E4D31E35AE12154F69A491A8
2DB119001D4762C8D78BCB005B770379B82D1B6BC91DE27C019057BE3473B8E5
0BDEDC139BC754783E89284EA1636D9E4C799AE7656755528C4A7D752EFBE1CA
F390F2848F21CA4938C4DF2501B1975D9C2A362B45702858E3974F385E4CB4CB
D19712A8DB471C02
‘‘‘

In step 720, the 601 Session Key, and 603 Encrypted Session Confirmation Package are returned in a redirect response to the Web Browser 102. The redirect response indicates the Reverse Proxy Server 301 has been authenticated with a valid digital signature and should request the application from the server. The Web Browser 102 saves the 601 Session Key and 603 Encrypted Session Confirmation Package to the Personal Computer's 101 File System 103 (see step 721).

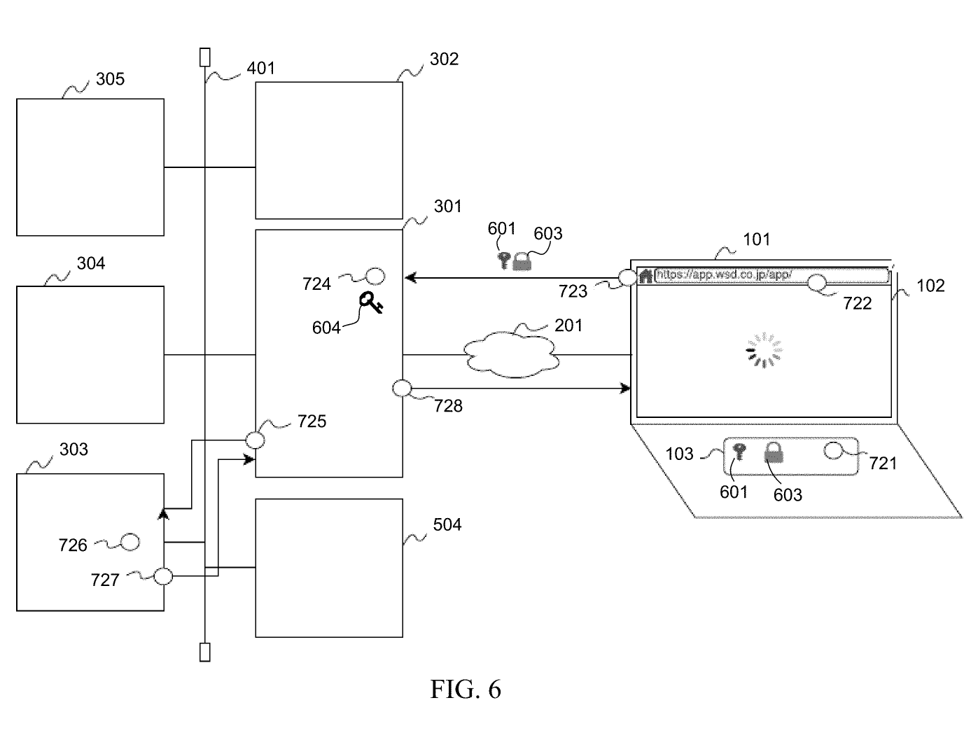

Referring now also to FIG. 6 in the drawings, a series of steps are executed. In step 722, the Web Browser 102 recognizes the redirect response from the Reverse Proxy Server 301 and changes the address bar 501 accordingly to indicate the intended location change. Thereafter, the Web Browser 102 sends a request (step 723) to the Reverse Proxy Server 301 for files required to execute the web application. The 601 Session Key and 603 Encrypted Session Confirmation are included in the request.

In step 724, the Reverse Proxy Server 301 decrypts the 603 Encrypted Session Confirmation package with the 604 Symmetric Key stored on the server to retrieve the original 602 Session Confirmation Package. The Reverse Proxy Server 301 confirms that the origin IP of the address matches that of the IP address included in the 602 Session Confirmation Package, that the browser agent matches that of the current request, and that the 601 Session Key included in the header of the request matches the one in 602 Session Confirmation Package. If any of these three values are different, the Reverse Proxy Server 301 returns an error response.

The 301 Reverse Proxy Server forwards the request to the 303 Application Server 303 (step 725). The Application Server 303 reads the requested files from the server's file system (step 726) and returns the files in a response to the Reverse Proxy Server 301 (step 727). Next, in step 728, the Reverse Proxy Server 301 returns the files in a response to the Web Browser 102.

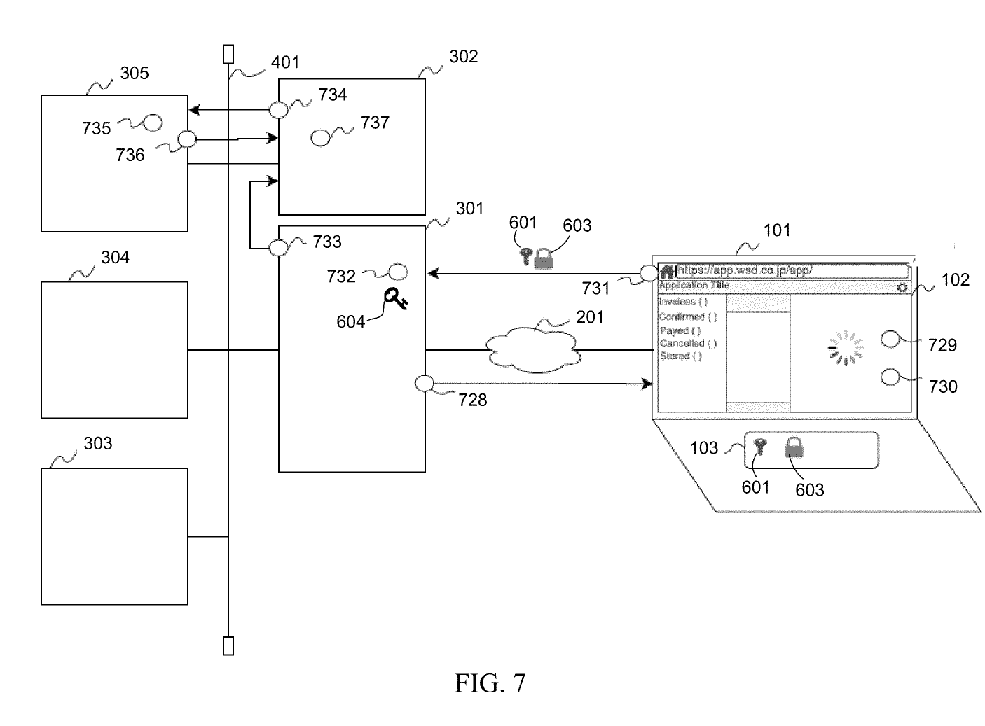

Referring now also to FIG. 7 in the drawings, a series of steps are executed. In step 729, the Web Browser 102 parses and renders the files for the application information provided from the Application Server 303. When the 102 Web Browser finishes rendering the files to display the elements on the screen (step 730), the Web Browser 102 begins to execute script files provided by the Application Server 303. Once the scripts are parsed and begin to execute, the Web Browser 102 is instructed to send a websocket connection request to the Reverse Proxy Server 301.

The 102 Web Browser proceeds to send a websocket connection request to the Reverse Proxy Server 301 (step 731). Included in the header of the request are the 601 Session Key and 603 Encrypted Session Confirmation Package in the header of the request. In step 732, the Reverse Proxy Server 301 decrypts the 603 Encrypted Session Confirmation package with the 604 Symmetric Key stored on the server to retrieve the original 602 Session Confirmation Package. The Reverse Proxy Server 301 confirms that the origin IP of the address matches that of the IP address included in the 602 Session Confirmation Package, that the browser agent matches that of the current request, and that the 601 Session Key included in the header of the request matches the one in 602 Session Confirmation Package. If any of these three values are different, the Reverse Proxy Server 301 returns an error response.

Next (step 733) the Reverse Proxy Server 301 forwards the request to the Websocket Server 302. In step 734, the 302 Websocket Server isolates the 601 Session Key from the request. The 302 Websocket Server then prepares a query to the Database Server 305, to check if the 601 Session Key has been logged out or not. Following which, the Database Server 305 performs the query (step 735). The Database Server 305 returns the results of the query (step 736). In step 737, the Websocket server 302 confirms that the 601 Session Key has not been logged out. As well as double checking the IP address of the origin and the browser agent of the current request with the ones stored in the Database server on step 716 for secondary verification of the current request.

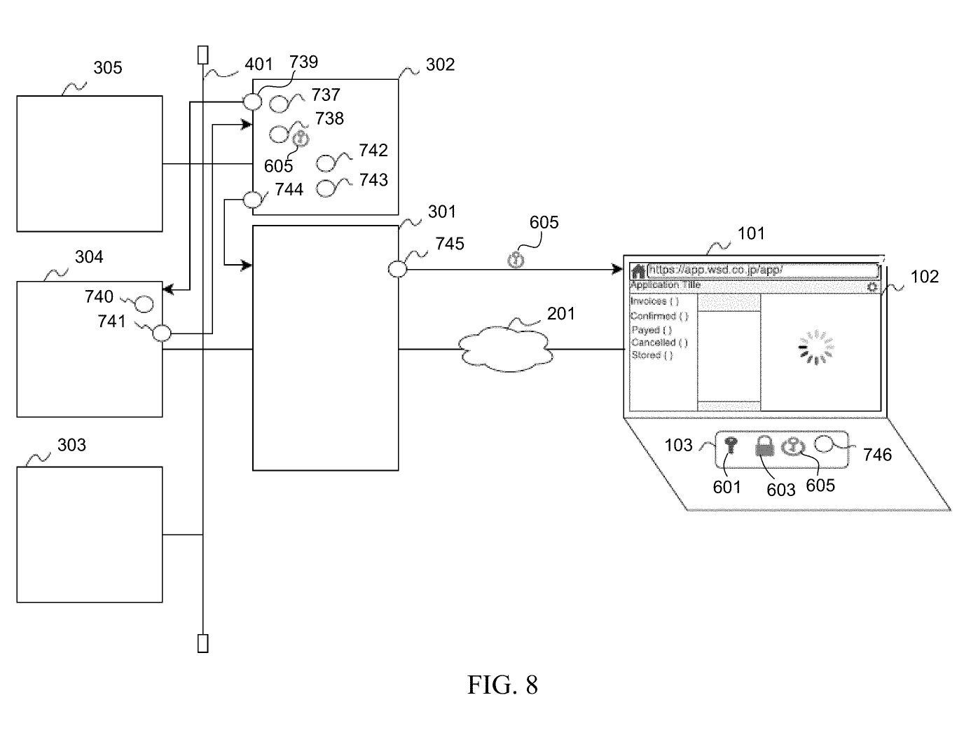

Referring now also to FIG. 8 in the drawings, a series of steps are executed. In step 738, the Websocket server 302 generates a 605 Session Verification Key. The 605 Session verification key is a similar structure to the original 601 Session Key. It is series of characters and number sufficiently random, such that it cannot easily be forged by a third party. The present application will use the sample value of “VnpGSMNZEa3phHZEtNN3” for the 605 Session Verification Key. In step 739, the Websocket Server 302 sends a request to the Data Store Server 304 to save the 601 Session Key and the 605 Session Verification Key, IP Address of the Web Browser 102 and the Browser agent of the Web Browser 102.

In step 740, the 304 Data Store Server saves the information provided from the 302 WebSocket Server in memory. The Data Stores uses the 601 Session Key as a key with the other information provided as the values. Such than when 601 Session Key is queried to the 304 Data Store Server, the server will return the following exemplary values:

‘‘‘
‘{

“ip_address” : “104.131.30.5”,
“session_verification_key” : “VnpGSMNZEa3phHZEtNN3”,
“browser_agent” : “Mozilla/5.0 (Windows NT x.y; rv:10.0)

Gecko/20100101 Firefox/10.0”
}‘
‘‘‘

In step 741, the Data Store server 304 returns a confirmation response to the WebSocket server 302. In step 742, the WebSocket Server 302 iterates over all of the current established websocket connections and attempts to send the 605 Session Verification Key to any connection with a matching 601 Session Key. The current WebSocket request from the 102 Web Browser is added to the list of current established websocket connections (step 743). If no matching sessions are detected in step 742, the Websocket 302 sends the 605 Session Verification Key to the Reverse Proxy Server 301 to be forwarded to the Web Browser 102 (step 744). The Reverse Proxy Server 301 then forwards the 605 Session Verification Key to the Web Browser 102 (step 745). The Web Browser 102 stores the 605 Session Verification Key to File System 103 (step 746).

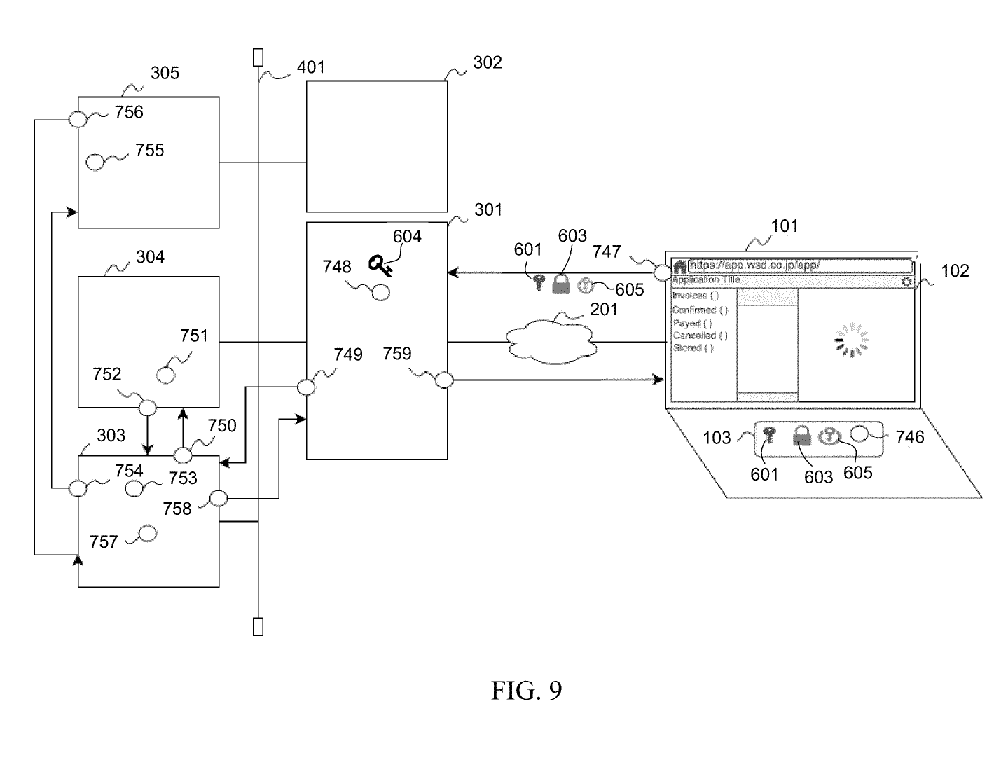

Referring now also to FIG. 9 in the drawings, a further series of steps are executed. In step 747, once the Web Browser 102 has received the 605 Session Verification Key, it is now authorized to send database related requests to the Application Server 303. For example, it will use it to get a set of values from the database, requires it to access the database; and requires it to identify the user. The Web Browser 102 sends a request to the Application Server 303 for information required by the application.

In step 748, the Reverse Proxy Server 301 decrypts the 603 Encrypted Session Confirmation package with the 604 Symmetric Key stored on the server to retrieve the original 602 Session Confirmation Package. The Reverse Proxy Server 301 confirms that the origin IP of the address matches that of the IP address included in the 602 Session Confirmation Package, that the browser agent matches that of the current request, and that the 601 Session Key included in the header of the request matches the one in 602 Session Confirmation Package. If any of these three values are different, the Reverse Proxy Server 301 returns an error response.

In step 749, the Reverse Proxy Server 301 forwards the request to the Application Server 303 wherein the Application Server 303 isolates (step 750) the 601 Session Key from the request sends a request to the Data Structure Store 304 for all data associated with the 601 Session Key stored there. The Data Store Server 304 performs the search request (step 751), which was stored in step 740. The Data Store Server 304 returns the data associated with the 601 Session Key (step 752). In step 753, the Application Server 303 checks the current request with the information retrieved from the Data Store Server 304. If the IP Address, 605 Session Verification Key, Browser Agent, or absence of any of these values differs from the values retrieved from the Data Store Server 304, the Application Server 303 will return an error response.

At step 754, the Application Server 303 prepares a database query to retrieve the data requested by the Web Browser 102 as performed in step 747, and sends a request to the Database Server 305. The Database Server 305 executes the query requested by the Application Server 303 (step 755). The Database Server 305 returns the results of the query to the Application server 303 (step 756). The Application Server 303 parses the results returned from the Database Server 305 (step 757). The Application Server 303 returns a response to the Reverse Proxy Server 301 (step 758). The Reverse Proxy Server 301 returns the response to the Web Browser 102 (step 759).

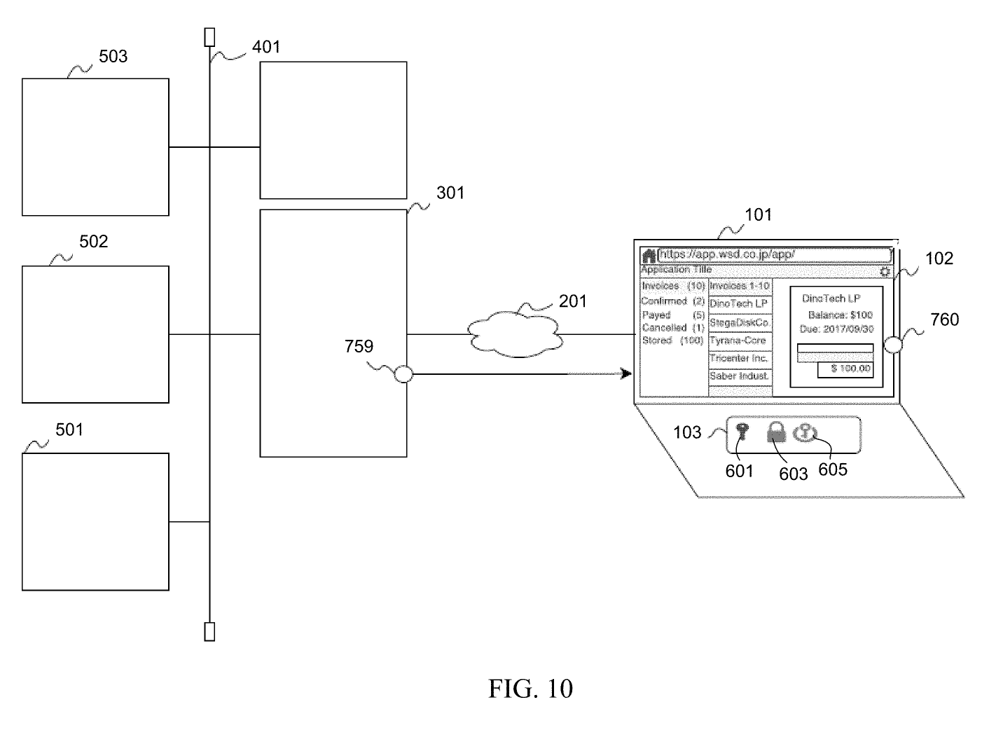

Referring now also to FIGS. 10-13 in the drawings, graphics showing the process of logging out of system 99 are illustrated. As seen in FIG. 10, the results of the http request requested by the Web Browser 102 from step 747 are displayed on the screen. In this state, the Web Browser 102 is considered authenticated, can make additional requests to the Application Server 303 by repeating steps 747 to 759 (see step 760).

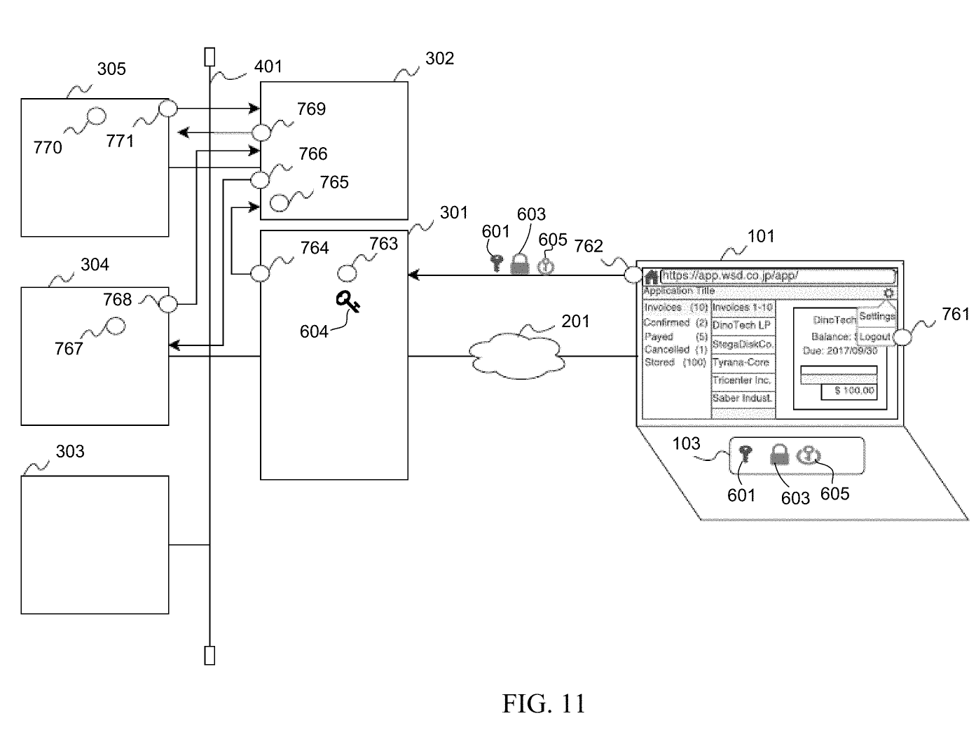

In FIG. 11, the process in which the session is terminated is shown. The user clicks a Logout button 505 from within the application (step 761). The Web Browser 102 sends a request to the Websocket Server 302 to terminate the session (step 762). In step 763, the Reverse Proxy Server 301 decrypts the 603 Encrypted Session Confirmation package with the 604 Symmetric Key stored on the server to retrieve the original 602 Session Confirmation Package. The Reverse Proxy Server 301 confirms that the origin IP of the address matches that of the IP address included in the 602 Session Confirmation Package, that the browser agent matches that of the current request, and that the 601 Session Key included in the header of the request matches the one in 602 Session Confirmation Package. If any of these three values are different, the Reverse Proxy Server 301 returns an error response. The Reverse Proxy Server 301 then forwards the request to the Websocket Server 302 (step 764). At this time, the Websocket Server 302 isolates the 601 Session key from the request header (step 765). The Websocket Server 302 sends a request to the 304 Data Store Server to remove any data associated with the 601 Session Key (step 766). The Data Store Server 304 removes any data associated with the 601 Session Key (step 767). The Data Store Server 304 returns a confirmation to the WebSocket Server 302 (step 768).

At step 769, the WebSocket Server 302 sends a request to the Database Server 305 to log the time of session termination, so that any additional requests to use the 601 Session Key are denied in step 737. The Database Server 305 executes the query (step 770). The Database Server 305 returns an acknowledgement response to the WebSocket Server 302 (step 771).

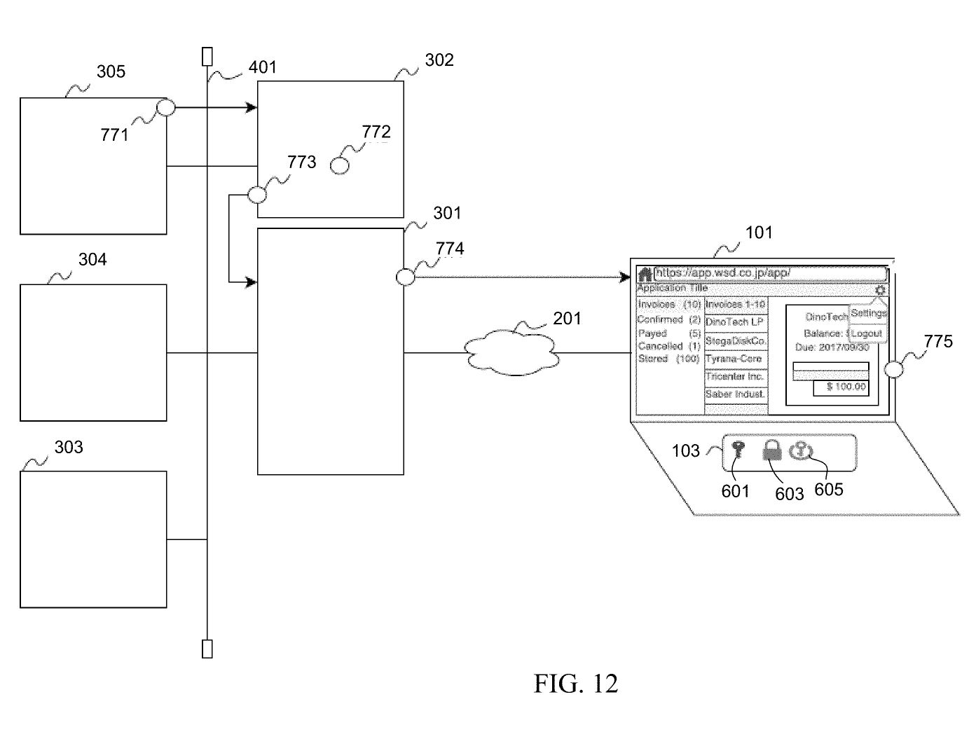

In FIG. 12, the Websocket Server 303 iterates over the list of the connected websocket with the same 601 Session Key and closes the connection (step 772). The Websocket Server 302 sends a close socket response to the Reverse Proxy Server 301 (step 773). The Reverse Proxy Server 301 forwards the close socket response to the Websocket Server 302 (step 774). The 102 Web Browser recognizes the websocket connection close event (step 775).

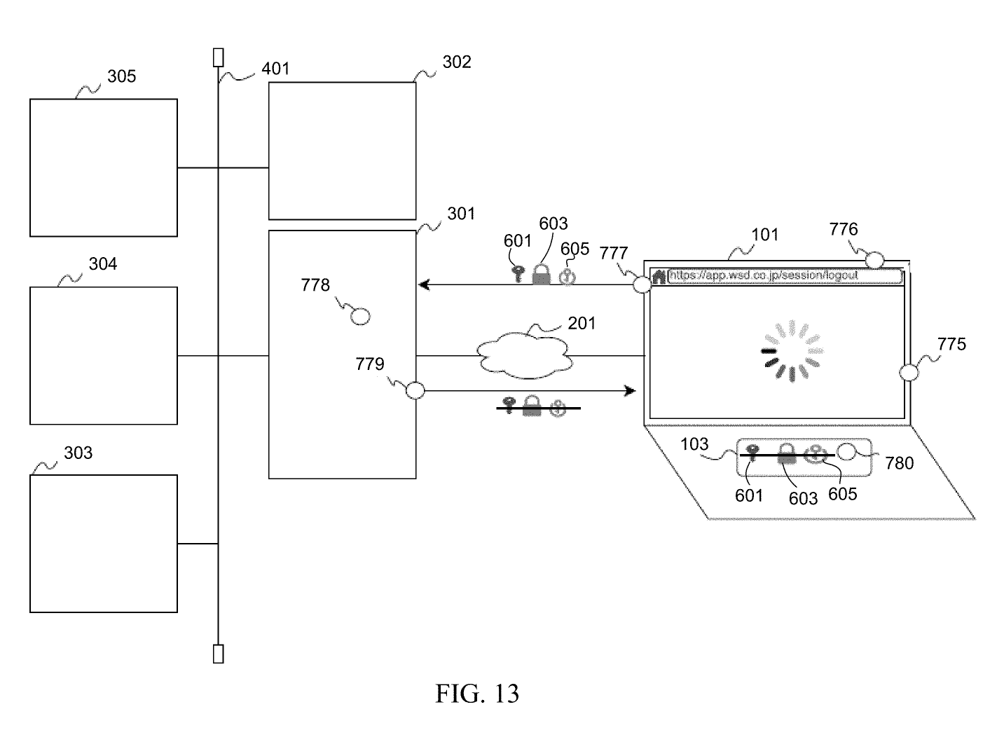

As seen in FIG. 13, once the websocket connection with the WebSocket Server 302 has been closed, scripts in the application instruct the Web Browser 102 to change the URL location to request removal of cookies from the Reverse Proxy Server 301 (see step 776). In step 777, the Web Browser 102 sends an http request to the Reverse Proxy Server 301 with the 601 Session Key, 603 Encrypted Session Confirmation Package and 605 Session Verification Key in the header of the request. At step 778, the Reverse Proxy Server 301 prepares a response to the Web Browser 102 to remove the 601 Session Key, 603 Encrypted Session Confirmation Package and 605 Session Verification Key from the Personal Computer's 101 File Storage 103. The Reverse Proxy Server 301 then returns a response to the Web Browser 102 (step 779). The Web Browser 102 removes the 601 Session Key, 603 Encrypted Session Confirmation Package and 605 Session Verification Key from the Personal Computer's 101 File Storage 103 (step 780).

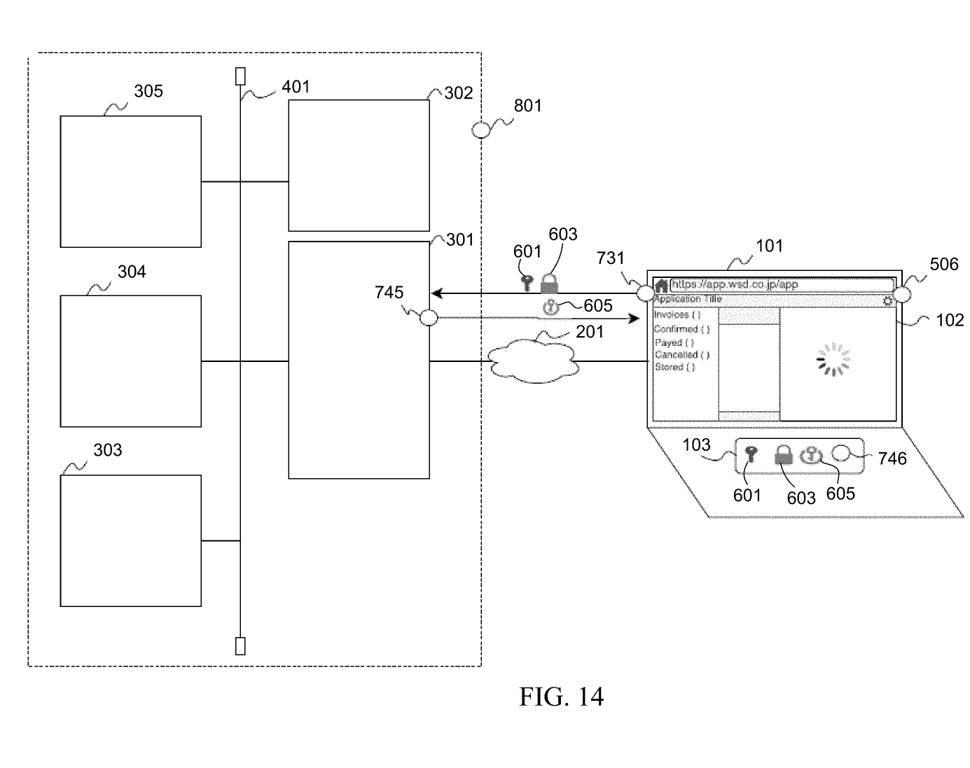

Referring now also to FIGS. 14-16 in the drawings, graphics showing an exemplary operation of the system 99 with multiple sessions and multiple connections is illustrated. More particularly, FIGS. 14, 15, and 16 provide disambiguation for the functionality of the 605 Session Verification Key and how it allows multiple sessions from multiple connections from a singular web client, but not from multiple host or multiple web clients. FIG. 14 shows the process of authenticating a single computer with a 605 Session Verification Key. For purposes of discussion herein, the Reverse Proxy Server 301, WebSocket Server 302, Application Server 303, Data Store Server 304 and Database Server 305, and the Network 401 will be grouped together and referred to as a single Endpoint 801. In step 731 in the present application, the Web Browser 102 sends the 601 Session Key and 603 Encrypted Session confirmation package to the Endpoint 801, and the 801 Endpoint returns a 605 Session Verification Key to the Web Browser 102 at it is the only web client with the current request.

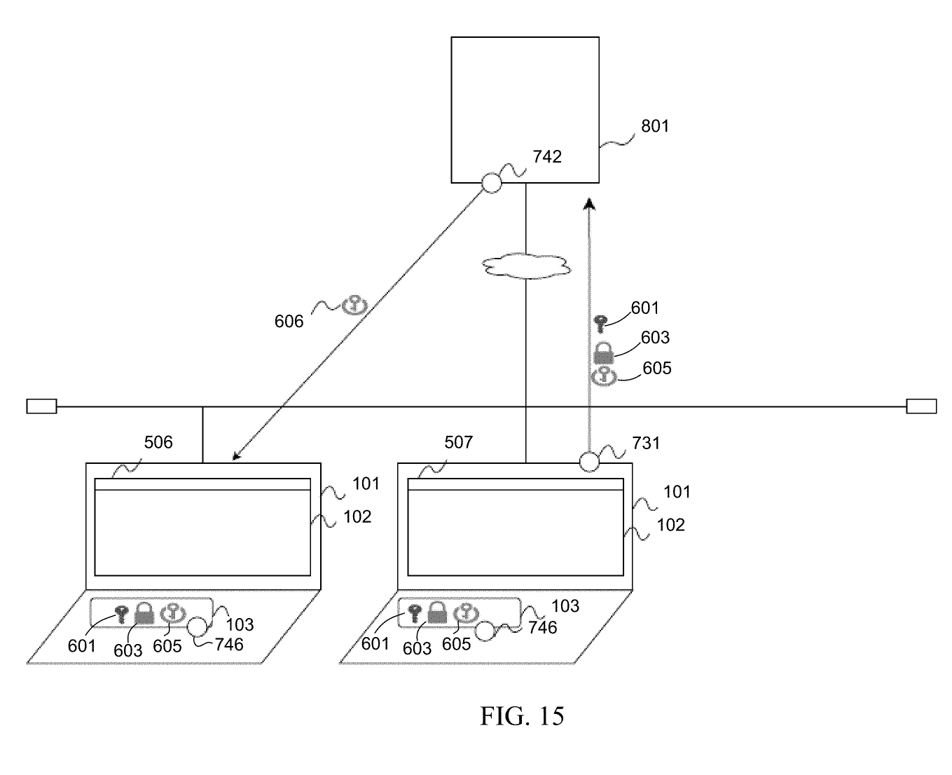

FIG. 15 depicts the action of opening up another browser tab on the same computer with the present application. The Figure depicts the same Personal Computer 101 as two computers for the purpose of illustration. The Left Tab 506 is the Web Browser 102 tab depicted in FIG. 13. When a new Tab 507 is opened, scripts inside the page will attempt to connect to the WebSocket Server 302, inside the Endpoint 801 as described in step 731 of the present application.

On step 742 of the present application, the WebSocket Server 302 will generate a 606 New Session Verification Key and send it to any clients with a matching 601 Session Key. If clients exist, the WebSocket Server 302 will not send the 606 New Session Verification Key to the Web Browser 102 client who sent the request.

In Step 742, the 303 WebSocket Server inside the 801 End-Point will send the 606 New Session Verification Key to existing connections. As the original tab 506 and new tab 507 share the same 103 File System on the same Web Browser 102, the effect of this is both tabs will be updated with the 606 New Session Verification Key, and therefore both will be able to send database-related requests to the Application server 303 inside the Endpoint 801.

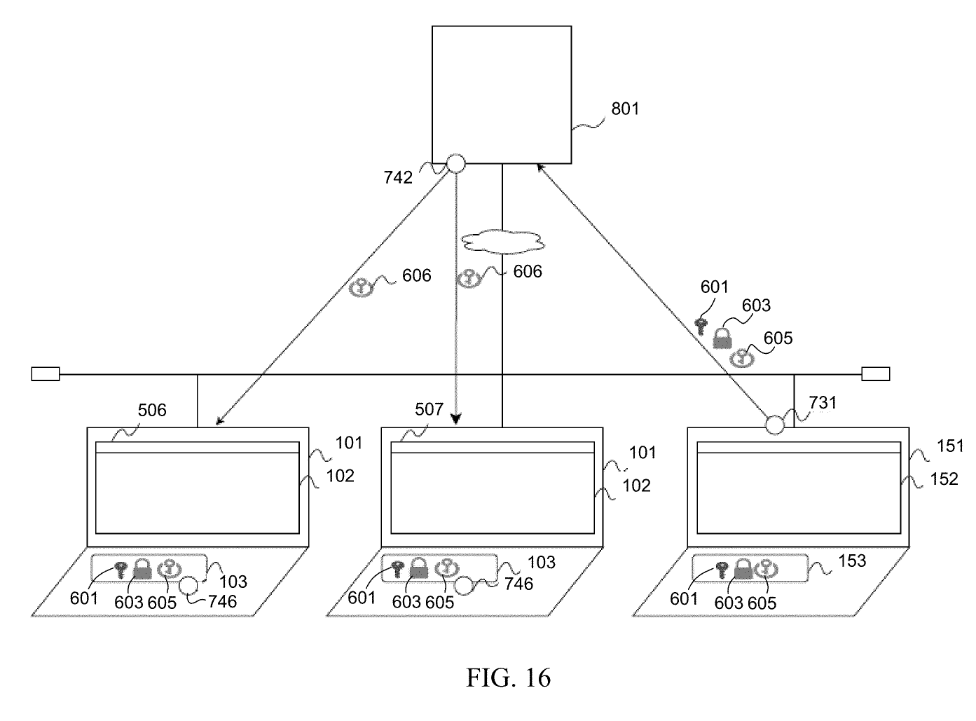

FIG. 16 depicts how the management of Session Verification Keys prevents other computers from hijacking the session. The same tabs, referred to by 506 and 507 are present in this figure from the previous FIG. 15. But an entirely new Personal Computer 151 and Web Browser 152 has been added. The Personal Computer 151 is that of a third party, which has been able to obtain the 601 Session Key, 603 Encrypted Session Verification Package and 605 Session Verification Key is on the same network as the Personal Computer 101.

Similar to the previous figure, the Web Browser 152 attempts to initiate a WebSocket Connection as that of step 731 in the present application. In the case of IP6 networks, this request will fail on step 732 of the present application as the IP address of the Personal Computer 151 will differ from that of the Personal Computer 101. However, on IPv4 networks, both of these devices will be seen as having the same origin.

In this case though, the WebSocket server will generate a new 606 Session Verification key, and send it to existing connections as seen step 742 of the present application, and update the associated data in the Data Store Server 304 to reflect the changes. As Personal Computer 151 and Personal Computer 101 do not share the same file system, this will cause the Web Browser 152 to have an outdated 605 Session Verification Key for making requests to the Application Server 303, causing requests to the server to be terminated as of step 753 of the present application.

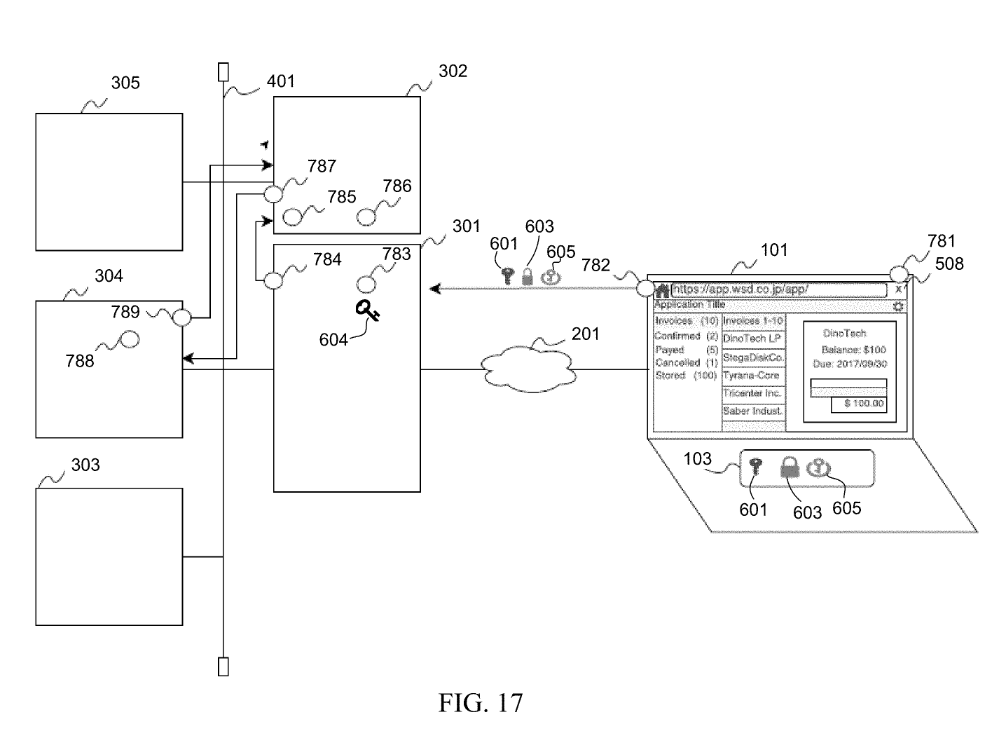

Referring now also to FIG. 17 in the drawings, the process in which sessions are terminated when the user does not logout from within the application, but closes the Web Browser 102 itself are illustrated. In step 781, the close browser button 508 is clicked. And the Web Browser 102 closes. At this point, the Web Browser 102 sends a websocket disconnect event to the server as it closes (step 782). From step 783, the Reverse Proxy Server 301 decrypts the 603 Encrypted Session Confirmation package with the 604 Symmetric Key stored on the server to retrieve the original 602 Session Confirmation Package. The Reverse Proxy Server 301 confirms that the origin IP of the address matches that of the IP address included in the 602 Session Confirmation Package, that the browser agent matches that of the current request, and that the 601 Session Key included in the header of the request matches the one in 602 Session Confirmation Package. If any of these three values are different, the Reverse Proxy Server 301 returns an error response. The Reverse Proxy Server 301 forwards the close socket event to the WebSocket Server 302 (step 784). The WebSocket Server 302 isolates the 601 Session Key from the request (step 785).

In step 786, the WebSocket Server 302 iterates over the list of currently active WebSocket connections to check if the current disconnected connection is the last connection for the given 601 Session Key. At step 787, if the disconnected WebSocket is indeed the last connected with the associated 601 Session Key, the WebSocket Server 302 makes a request to the Data Store Server 304 to remove any associated data for the 601 Session Key. The Data Store Server 304 performs the remove request (step 788). The Data Store Server 304 returns a confirmation request to the WebSocket Server 302 (step 789).

The current application has many advantages over the prior art including at least the following, the ability to provide a dual layer of protection for verification purposes to secure the dissemination of information over a network.

A summary of the numerical identifiers are provided herein:
101—Personal Computer
102—Browser
103—Filesystem
201—Internet
301—Reverse Proxy Server
302—WebSocket Server
303—Application Server
304—Data Structure Server
305—Database Server
401—Internal Network
501—Address Bar
502—Username Input Field
503—Password Input Field
504—Form Submit Field
505—Logout Button
506—Left Tab
507—Right Tab
508—Close button
601—Session Key
602—Session Confirmation Package
603—Encrypted Session Confirmation Package
604—Symmetric Key
605—Session Verification Key
606—New Session Verification Key

The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A system for verifying the origin of a request over a network, comprising:
a personal electronic device having a processor, a memory storage device, and an input/output interface, being configured for the retrieving, processing, and transmitting of data through the network,
one or more databases in communication with the personal electronic device over the network,
one or more servers in communication with the personal electronic device over the network, the one or more servers regulating the transmission of information to and from the one or more databases, the one or more servers generating a unique session ID to identify a particular session of a user for subsequent uses; and
a unique identifying session confirmation package including an IP address, the session ID, and a browser agent, the session confirmation package generated by the one or more servers and configured to restrict access to files on the one or more databases, the session confirmation package used to authenticate subsequent access to the one or more servers and one or more databases over the network.

2. The system of claim 1, wherein the unique identifying session confirmation package is encrypted.

3. The system of claim 1, wherein the uniquely identifying session confirmation package is stored in the one or more servers.

4. The system of claim 1, wherein the uniquely identifying session confirmation package is transmitted to the personal electronic device.

5. The system of claim 1, wherein access to information on the server requires verification of the session ID and the session confirmation package.

6. The system of claim 1, wherein the one or more servers and one or more databases are configured to generate a session verification

7. The system of claim 1, wherein the one or more servers are configured to generate a session verification key based upon verification of the session ID and the session confirmation package.

8. The system of claim 7, wherein the session verification key is generated within the network and subsequent to that of the session confirmation package and the session ID.

9. A method of verifying the origin of a request over a network, the network having a server, a database, and a personal electronic device, the method comprising:
transmitting user identification data from the personal electronic device to the server;
authenticating the user identification data with the server and the database, and transmitting authentication back to the personal electronic device;
creating a session ID on the server to identify a computer session over the network;
forming a session confirmation package containing data related to the IP address, a browser agent used by the personal electronic device, and the session ID;
encrypting the session confirmation package from a unique server key; and
returning to the personal electronic device the session ID and the session confirmation package;
wherein identification of the user and personal electronic device includes verifying the session ID and session confirmation package coincide with a particular IP address as well as verifying the session ID matches the session ID in the session confirmation package.

10. The method of claim 9, further comprising:
generating a session verification key used to identify a particular user and personal electronic device.

11. The method of claim 10, wherein the session verification key is generated within the network and subsequent to that of the session confirmation package and the session ID.

12. The method of claim 10, wherein the session verification key is generated when the personal electronic device accesses the server over the network.

13. The method of claim 10, wherein the session verification key is updated upon access of the personal electronic device on the network.

14. The method of claim 13, wherein the session verification key is updated on existing personal electronic devices already on the network when a third party electronic device attempts to access information over the network using the session ID, session confirmation package, and session verification key.

15. The method of claim 14, wherein the third party electronic device retains an outdated session verification key.
